(19) United States
(12) Patent Application Publication
(10) Pub. No.: US 2015/0291226 A1
(43) Pub. Date: Oct. 15, 2015

(54) AREAL COMPONENT ARRANGEMENT FOR A VEHICLE BODY, VEHICLE BODY WITH THE AREAL COMPONENT ARRANGEMENT AND METHOD FOR WELDING AN AREAL COMPONENT OF THE AREAL COMPONENT ARRANGEMENT

(71) Applicant: GM GLOBAL TECHNOLOGY OPERATIONS LLC, Detroit, MI (US)

(72) Inventor: Marcus LANGE, Pfungstadt (DE)

(73) Assignee: GM GLOBAL TECHNOLOGY OPERATIONS LLC, Detroit, MI (US)

(21) Appl. No.: 14/683,155

(22) Filed: Apr. 10, 2015

(30) Foreign Application Priority Data
Apr. 10, 2014 (DE) 102014005262.1

(51) Int. Cl. B62D 29/00; B62D 25/02; B23K 31/02

(52) U.S. Cl. CPC B62D 29/001; B23K 31/02; B62D 25/02

(57) ABSTRACT

An areal component arrangement for a vehicle body is disclosed. The areal component arrangement includes a sandwich structure having a metallic top and bottom layer and a non-metallic core layer. The areal component has an areal component section surrounded by outer edges of the areal component and having a reduced thickness with respect to the thickness the sandwich structure. The areal component arrangement further includes a welding partner which is welded to the areal component in the areal component section.

### CROSS-REFERENCE TO RELATED APPLICATION

This application claims priority to German Patent Application No. 102014005262.1, filed Apr. 10, 2014, which is incorporated herein by reference in its entirety.

### TECHNICAL FIELD

This present disclosure pertains to an areal component arrangement for a vehicle body, and more particularly to an areal component having sandwich structure including a metallic top and bottom layer, a non-metallic core layer and a welding partner.

### BACKGROUND

In vehicle construction it is known to use so-called lightweight sheets for the sake of weight reduction. Such lightweight sheets usually have a sandwich construction with multiple layers. The top and bottom layers are often of metal, whereas a core layer arranged in between includes plastic material. Such lightweight sheets are usually anchored in the vehicle body and/or in the vehicle assembly by riveting, clinching or gluing. Possibilities already exist of welding such lightweight sheets together.

The publication FR 2,713,119 for example describes a first and a second lightweight sheet which has a metallic bottom and top layer and a synthetic core layer. In order to weld the two lightweight sheets together, the bottom layer and the core layer is removed in the marginal region of the first lightweight sheet and the top layer and the core layer in the marginal region of the second lightweight sheet. Because of this, the top layer of the first lightweight sheet can be welded to the bottom layer of the second lightweight sheet.

### SUMMARY

The present disclosure provides a functionally improved areal component of an areal component arrangement that is easily connected. The areal component arrangement for a motor vehicle in particular for a body of a passenger car or utility vehicle is proposed. The areal component arrangement includes an areal component with a sandwich structure. The sandwich structure preferably includes at least three sandwich layers. As sandwich layers, the areal component includes a metallic top layer, a metallic bottom layer and a non-metallic core layer. In particular, the metallic top layer is arranged on a top side, the metallic bottom layer on a bottom side and the non-metallic core layer between the top layer and the bottom layer. Optionally, the areal component may include as sandwich layers the aforementioned metallic top and bottom layer, the non-metallic core layer and at least one further layer. The areal component has an initial thickness. An amount of the starting thickness corresponds in particular to a sum of the thickness of the metallic top layer, the non-metallic core layer and the metallic bottom layer.

The areal component further includes at least one areal component section. The areal component section is surrounded by outer edges of the areal component and arranged spaced therefrom. Preferably, the areal component section is enclosed by a margin and/or marginal region. In particular, the areal component section is arranged centrally and/or in the middle in the areal component. Specifically, the areal component section is not arranged on the margin, in the marginal region, and/or on the outer edges of the areal component. For example, the areal component section is formed or includes a depression and/or indentation in the areal component. In the areal component section, the areal component has a reduced thickness which is reduced compared to the starting thickness. In particular, the amount of the reduced thickness corresponds to a sum of the thickness of the top layer and the bottom layer.

The areal component arrangement includes a welding partner, to which the areal component in the at least one areal component section is welded. It is advantageous that through the possibility of welding the areal component to the welding partner a time-saving and cost-effective connection of the areal component to the welding partner is made possible. Connecting techniques such as riveting, clinching or gluing of the areal component can be advantageously omitted. Because of this, assembly time of the areal component can be reduced and costs saved because of this.

In a preferred embodiment of the present disclosure, the metallic top layer and the metallic bottom layer contact one another in the areal component section. In particular, the non-metallic core layer is absent in the at least one areal component section. The non-metallic core layer is preferably displaced out of the areal component section during a forming process of the areal component. In particular, the starting thickness through the absence and/or the displacement of the non-metallic core layer in the areal component section is diminished to the reduced thickness.

A preferred implementation of the present disclosure provides that the areal component and the welding partner are resistance spot welded in the areal component section. In particular, the areal component and the welding partner are welded together by passing electric current through. A prerequisite for this is electrical conductivity between the areal component and the welding partner.

It is advantageous that the areal component in the areal component section, because of the absence and/or the displacement of the non-metallic core layer and the contacting of the metallic top layer and of the metallic bottom layer achieved because of this can be welded to a welding partner without problem, in particular resistance spot welded. In particular, there is an electrically conductive connection between the metallic top and bottom layers contacting one another, which in the presence of the non-metallic core layer would be impaired or interrupted. Specifically, the non-metallic core layer during welding would have an insulating effect, thereby restricting or preventing it.

In a preferred configuration of the present disclosure, the areal component is designed as a lightweight sheet. By using lightweight sheets in vehicle construction, in particular for producing the vehicle body, a weight of the vehicle body can be reduced and because of this a fuel consumption of the vehicle produced from the vehicle body reduced.

In a preferred implementation of the present disclosure, the metallic top layer is designed as a sheet top layer, in particular of a steel sheet or an aluminum sheet. Preferably, the metallic bottom layer is designed as a sheet bottom layer, in particular of a steel sheet. Alternatively or optionally complementarily, the non-metallic core layer is designed as a plastic core layer. By providing the plastic core layer between the sheet top layer and the sheet bottom layer an own weight of the areal component can be reduced and the aforementioned advantages with respect to the weight reduction of the vehicle body and the reduction of the fuel consumption realized.

For example, the welding partner is designed as an areal component including a metal. This can be for example a sheet, in particular a steel sheet or aluminum sheet. Particularly preferably, the welding partner is designed as a further areal component with a further areal component section. In particular, the further areal component and/or the further areal component section are designed structurally identical to the previously described areal component and/or areal component section. By welding multiple lightweight sheets to the vehicle body, the same has the reduced weight. This has an in particular positive effect on the fuel consumption of the vehicle.

The starting thickness of the areal component, in particular the sum of the thickness of the top layer, core layer and bottom layer preferably amounts to a maximum of 1.50 millimeter, in particular a maximum of 1.20 millimeter, and specifically a maximum of 1.00 millimeter. Alternatively or optionally complementarily the starting thickness of the areal component amounts to at least 0.60 millimeter, preferably at least 0.70 millimeter.

The reduced strength of the areal component in the areal component section, in particular the sum of the thickness of the top layer and of the bottom layer preferably amounts to a maximum of 0.90 millimeter, in particular a maximum of 0.80 millimeter, specifically a maximum of 0.70 millimeter. Alternatively or optionally complementarily the reduced thickness of the areal component in the areal component section amounts to at least 0.40 millimeter, preferably at least 0.50 millimeter.

In a preferred implementation of the present disclosure, the metallic top layer and/or the metallic bottom layer has a layer thickness of a maximum of 0.50 millimeter, preferably of a maximum of 0.40 millimeter, in particular of a maximum of 0.30 millimeter. Alternatively or optionally complementarily, the layer thickness of the metallic top layer and/or the metallic bottom layer amounts to at least 0.20 millimeter.

The non-metallic core layer for example has a layer thickness of at least 0.2 millimeter and/or of a maximum of 0.6 millimeter, preferably of a maximum of 0.4 millimeter.

A further subject of the present disclosure relates to the vehicle body with the areal component arrangement according to the summary set forth above.

A further subject of the present disclosure relates to a method for welding, in particular resistance spot welding the areal component of the areal component arrangement according to the summary set forth above. Within the scope of the method, the areal component is formed in a forming process. For example, the forming process is a deep-drawing process. Preferably, the areal component is suitably shaped in the forming process in order to form during the assembly later on, in particular together with the welding partner, the vehicle body or a part of the vehicle body. During the forming process, the starting thickness of the areal component in the areal component section is reduced to the reduced thickness.

In a preferred implementation of the method, the non-metallic core layer is displaced out of the areal component section through the forming process. In particular, a forming tool for carrying out the forming process is modified in such a manner that the non-metallic core layer is displaced out of the areal component section during the forming of the areal component. Alternatively or optionally complementarily, the non-metallic core layer is heated in the areal component section during the forming process. This is achieved for example by induction, blowing of the non-metallic core layer with hot air and/or by heating of the relevant forming tool section. Because of this it is ensured that the metallic top and bottom layer contact one another and welding of the areal component to the welding partner is thereby possible. In particular, the displaced non-metallic core layer cannot exert an insulating effect on the metallic bottom and top layer and not impair or prevent the welding together.

Preferably, the areal component, in particular in the areal component section, is welded to the welding partner, in particular resistance spot welded. Specifically, a spot weld after the welding is arranged in the at least one areal component section.

### BRIEF DESCRIPTION OF THE DRAWINGS

The present disclosure will hereinafter be described in conjunction with the following drawing figures, wherein like numerals denote like elements.

FIG. 1 a perspective top view of an areal component arrangement with an areal component and a welding partner, wherein the areal component includes an areal component section in which it is welded to the welding partner;

FIG. 2 a sectional view of the areal component from FIG. 1, wherein a section line runs through the at least one areal component section; and

FIG. 3 a schematic sequence representation of a method for welding the areal component to the welding partner.

Parts corresponding to one another or structurally identical parts are provided with the same reference characters in the figures in each case.

### DETAILED DESCRIPTION

The following detailed description is merely exemplary in nature and is not intended to limit the present disclosure and/or uses of the present disclosure. Furthermore, there is no intention to be bound by any theory presented in the preceding background of the present disclosure or the following detailed description.

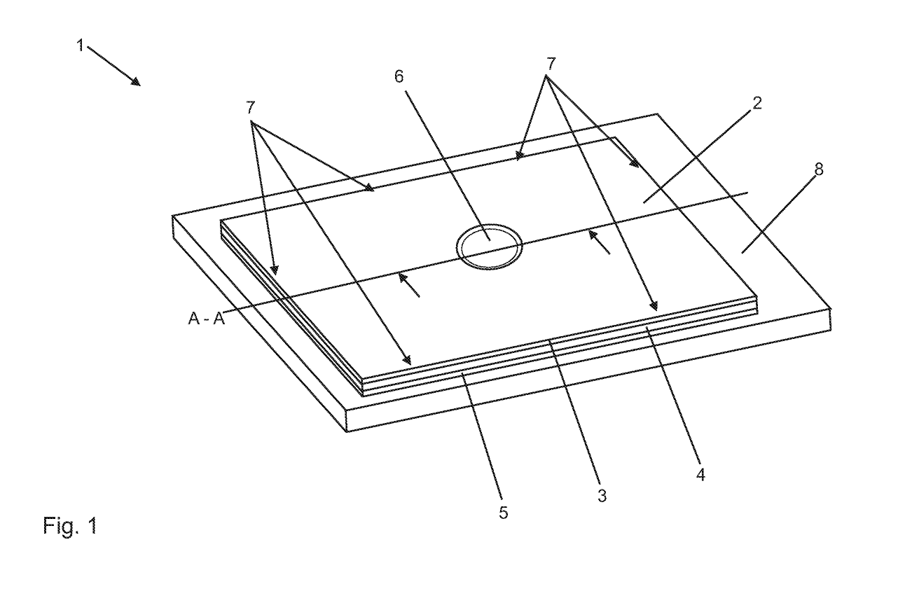

FIG. 1 shows a perspective top view of an areal component arrangement 1 as an exemplary embodiment of the present disclosure. The areal component arrangement 1 includes an areal component 2 and a welding partner 8, to which the areal component 2 is welded. The welding partner 8 is formed as a further metallic areal component. Alternatively, the welding partner 8 is formed as a structurally identical further areal component with a structurally identical at least one further areal component section.

The areal component 2 is designed as a lightweight sheet. It includes a metallic top layer 3, a non-metallic core layer 4 and a metallic bottom layer 5. The metallic top layer 3 is designed as a sheet top layer, e.g. of a steel sheet or aluminum sheet and the metallic bottom layer 5 as a sheet bottom layer, likewise for example of a steel sheet or of an aluminum sheet. In particular, the metallic top and bottom layer 3, 5 are formed of a sheet with a layer having a maximum thickness of 0.50 millimeters each, preferably having a maximum thickness of 0.40 millimeters, in particular having a maximum thickness of 0.30 millimeter and/or having a thickness of at least 0.20 millimeter.

The non-metallic core layer 4 is arranged between the metallic top and bottom layer 3, 5 and preferably is formed as a plastic core layer having a layer thickness of at least 0.2 millimeter, and/or having a maximum thickness of 0.6 millimeter, and preferably having a maximum thickness of 0.4 millimeter. By introducing the non-metallic core layer 4 between the top and bottom layer 3, 5 the areal component 2 may be formed as a lightweight sheet with a reduced weight. Because of this, the vehicle body formed of the lightweight sheet can be reduced in its weight and a fuel consumption of the vehicle formed out of the vehicle body reduced.

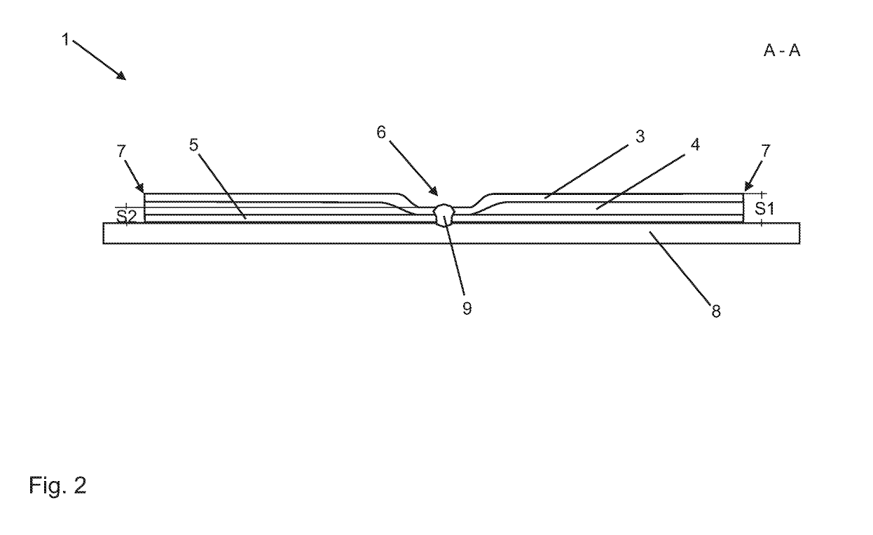

The areal component 2 includes at least one areal component section 6. The areal component section 6 is surrounded by a margin, marginal region and/or by outer edges 7 of the areal component 2. In particular, the areal component section 6 is arranged interior of the outer edge, and/or centrally in the areal component 2. In this regard, the areal component section 6 is arranged spaced from the margin, marginal region and/or from the outer edges 7. FIG. 2 shows the areal component arrangement 1 from FIG. 1 in a sectional view, wherein a section line A-A runs parallel to the areal component 2 and through the areal component section 6. The areal component 2 has an initial thickness S1, the amount of which corresponds to the sum of the thickness of the metallic top layer 3, the non-metallic core layer 4 and the metallic bottom layer 5.

The areal component 2 may be formed in a forming process, in particular in a deep-drawing process in order to form a part of the vehicle body later on. A forming tool, for example deep-drawing tool is modified so that the non-metallic core layer 4 is displaced out of the areal component section 6. To completely displace the non-metallic core layer 4 out of the areal component section 6 it may be heated during the forming process, for example by induction, blowing of the non-metallic core layer 4 with hot air or by heating the relevant forming tool section which forms the at least one areal component section 6.

Because of the complete displacement of the non-metallic core layer 4, the metallic top layer 3 and the metallic bottom layer 5 contact one another in the areal component section 6. In particular, the starting thickness S1, because of the absence of the non-metallic core layer 4 in the at least one areal component section 6 is reduced to a reduced thickness S2. The amount of the reduced thickness S2 corresponds to the sum of the thickness of the top layer 3 and the bottom layer 5. The areal component 2 and the welding partner 8 are welded to one another in the areal component section 6, in particular resistance spot welded. The spot weld 9 is arranged in the at least one areal component section 6. Displacing the non-metallic core layer 4 out of the at least one areal component section 6 and the contacting of the metallic top layer 3 and the metallic bottom layer 5 this makes possible welding the areal component 2 to the welding partner 8 without problem, since an insulating effect between the metallic top and bottom layer 3, 5 through the non-metallic core layer 4 has been excluded. Through the possibility of welding, more elaborate connecting methods such as riveting, clinching or gluing can be omitted.

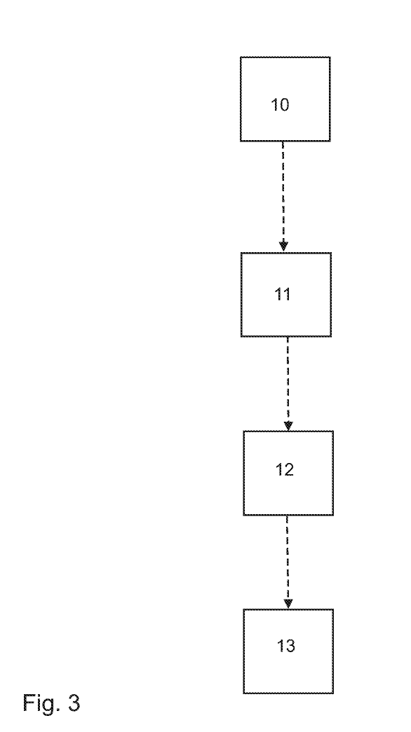

FIG. 3 shows a schematic sequence of a method for welding the areal component 2 of the areal component arrangement 1 to the welding partner 8. The areal component 2 is formed during the forming process and the original thickness S1 of the areal component 2 in the at least one areal component section 6 diminished from the original thickness S1 to the reduced thickness S2 at block 10. At block 11, the method may optionally include heating the non-metallic core layer 4 of the areal component 2 during the forming process. The non-metallic core layer 4 of the areal component 2 is displaced out of the at least one areal component section 6 during the forming process at block 12. The areal component 2 is welded to the welding partner 8 in the at least one areal component section 6, in particular resistance spot welded at block 13.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-15. (canceled)

16. An areal component arrangement for a vehicle body comprising an areal component having:
a sandwich structure including a metallic top layer, a metallic bottom layer and a non-metallic core layer interposed between the metallic top and bottom layer, wherein the sandwich structure has an initial thickness;
at least one areal component section surrounded by an outer edge of the areal component and arranged spaced therefrom, wherein the areal component section has a reduced thickness with respect to the initial thickness of the sandwich structure; and
a welding partner which is welded to the areal component in the at least one areal component section.

17. The areal component arrangement according to claim 16, wherein the metallic top layer and the bottom layer contact one another in the at least one areal component section.

18. The areal component arrangement according to claim 16, further comprising a resistance spot weld formed between the welding partner and the areal component in the at least one areal component section.

19. The areal component arrangement according to claim 16, wherein the sandwich structure further comprises a metallic sheet top layer, a metallic sheet bottom layer and a plastic core layer.

20. The areal component arrangement according to claim 16, wherein the areal component is formed as a lightweight sheet.

21. The areal component arrangement according to claim 5, wherein the welding partner comprises a second sandwich structure including a second metallic top layer, a second metallic bottom layer and a second non-metallic core layer, and a second areal component section surrounded by an outer edge of the welding partner and arranged spaced therefrom, wherein the welding partner and the areal component being welded together at the areal component section and the second areal component section.

22. The areal component arrangement according to claim 16, wherein the initial thickness is in the range of 0.9 millimeters and 1.5 millimeters.

23. The areal component arrangement according to claim 22, wherein the reduced thickness is in the range of 0.3 millimeters and 0.9 millimeters.

24. The areal component arrangement according to claim 16, wherein the metallic top layer and the metallic bottom layer each have a layer thickness in the range of 0.1 millimeters and 0.50 millimeters.

25. A vehicle body with the areal component arrangement according to claim 16.

26. A method for welding a areal component of a areal component arrangement to a welding partner according to claim 16, and further comprising forming the areal component in a forming process such that the initial thickness of the areal component in the at least one areal component section is reduced to the reduced thickness.

27. The method according to claim 26, further comprising forming the areal component in a deep-drawing process.

28. The method according to claim 26, further comprising heating the non-metallic core layer in the at least one areal component during the forming process.

29. The method according to claim 26, further comprising displacing the non-metallic core layer during the forming process out of the at least one areal component section.

30. The method according to claim 26, further comprising resistance spot welding the areal component in the at least one areal component section to the welding partner.
